(19) United States
(12) Patent Application Publication
(10) Pub. No.: US 2006/0065670 A1
(43) Pub. Date: Mar. 30, 2006

(54) Packaging device for dispensing security-protected units of product

(75) Inventors: Pierre Doublet, Saint Brice (FR); Nathalie Vast, Verrieres Ie Buisson (FR)

Correspondence Address: OLIFF & BERRIDGE, PLC, P.O. BOX 19928, ALEXANDRIA, VA, 22320, US

(73) Assignee: Arjowiggins Security, Issy Ies Moulineaux Cedex (FR)

(21) Appl. No.: 11/230,685

(22) Filed: Sep. 21, 2005

Related U.S. Application Data
(60) Provisional application No. 60/612,650, filed on Sep. 23, 2004.

(30) Foreign Application Priority Data
Sep. 21, 2004 (FR) 04 52119

(51) Int. Cl. B65G 47/14; G07F 11/00; B65D 83/04

(52) U.S. Cl. 221/1; 206/459.5; 221/2; 206/534

(57) ABSTRACT

A packaging device may include a plurality of packaging elements. Each of the packaging elements may include at least one unit of a product. The packaging units may be fixed to each other or contained in a single outer container. The packaging device may also include a plurality of safety elements belonging to the packaging elements or fixed to them. The safety elements positioned so as to allow the combined dispensing of at least one packaging element and at least one safety element.

### CROSS-REFERENCE TO RELATED APPLICATIONS

This non-provisional application claims the benefit of French Application No. 04 52119 filed on Sep. 21, 2004, and U.S. Provisional Application No. 60/612,650 filed on Sep. 23, 2004, the entire disclosures of which are incorporated herein by reference.

The present invention relates to the dispensing of units of a product, for example, a proprietary medicine, which can be delivered to a patient at a community pharmacy or at a hospital pharmacy.

### BACKGROUND

Proprietary medicines are customarily made up in the form of units and then packaged. At the present time, particularly in accordance with European regulations, the term “primary packaging” denotes a receptacle or any other form of packaging in direct contact with the proprietary medicine, and the term “outer container” denotes the container in which the primary packaging is placed. A quantity of units in each outer container is generally determined in advance by agreement between the pharmaceutical laboratory and the local authorities responsible for public health regulations in the particular country.

In particular, the primary packaging may take the form of blister packs, sachets or pouches, particularly those made from sealed and/or bonded sheets. The outer container may take the form of a paperboard box. In such a case, usually the whole box is sold by the pharmacist to the patient.

However, in some cases, the patient may not consume all the units of the proprietary medicine that have been sold to him, since community pharmacists are not authorized to “unpackage” pharmaceutical formulations in some countries.

One method which may be used to dispense an exact number of units of the proprietary medicine for each course of treatment is that of packaging the units in bulk, for example, in jars, and delivering the exact number to the patient simply by counting the units out.

Patent application GB 2,223,001 proposes, for example, a packaging system that enables a pharmacist to deliver a requisite number of units of proprietary medicines easily, while keeping the medicines in their original packaging.

Also, in the field of blister packaging, patent application FR 2,786,158 discloses a packaging device in the form of a ribbon comprising one or two cells across its width, wound onto itself to form a roll. This application also describes a reel for extracting a desired number of blister packs.

### SUMMARY

Leaving aside the fact that, for regulatory reasons, not all countries accept the practice of bulk packaging and counting out units, such a method clearly requires a large number of handling operations by the pharmacist, and may prove to be tiresome. It also has the drawback of not being suited to proprietary medicines other than tablets, and not being suited to tablets that are affected by moisture or repeated handling.

In addition to a problem of matching a number of units of proprietary medicine to a prescribed treatment, security of dispensed products is a matter of constant concern, both as regards to traceability and to prevention of counterfeiting.

Discussions are taking place in various countries, and particularly in the United States, with the purpose of establishing reliable authentication systems to overcome these problems.

Exemplary embodiments of the present invention may provide a solution to this problem of security, for example, in the case of proprietary medicines or medical products, including vaccines and syringes, and also for other products, particularly those of small size and/or high added value that require security protection, such as telephone cards, spare parts, jewelry and watches.

Exemplary embodiments of the invention relate to a packaging device having: a plurality of packaging elements, each comprising at least one unit of a product, the plurality of packaging elements being fixed to each other or contained in a single outer container; a plurality of security elements belonging to the packaging elements or fixed to the packaging elements, and positioned so as to allow combined dispensing of at least one packaging element and at least one security element.

It should be understood that the term “security element” as used herein is intended to encompass various types of security, including, for example, safety, theft prevention, protection, identification, and the like, this list not being exhaustive. As such, the various security elements described herein should be understood as elements that have at least one function related to security, such as the various purposes and benefits suggested by the description.

In exemplary embodiments, the packaging device may comprise a strip formed by a sequence of packaging elements.

Two adjacent packaging elements may be separated by a weakening line. This line may be suitable for manual or automated detachment, and may comprise, for example, a series of holes or removals of material, a pre-cut or a weakening, for example, imparted by heat treatment, such as by a laser.

The strip may be packaged in roll form. Alternatively or additionally, the strip may be packaged by being folded, for example, with an accordion fold.

In exemplary embodiments, the packaging elements may be assembled by a binding. For example, the packaging elements may be bonded or welded to each other or may be connected by spirals or staples, or by any other appropriate fixing mechanism or arrangement.

In exemplary embodiments, the packaging elements may be enclosed, in a random arrangement, for example, in a single outer container, and each packaging element may include at least one security element.

Each packaging element may comprise one or more product units. When each packaging element comprises a plurality of product units, the units may be arranged, for example, in one or more lines.

A number of product units in each packaging element may be, for example, in a range from 1 to 10.

In exemplary embodiments, each packaging element may comprise a blister pack. In a conventional way, each blister pack may have one or more cells, generally made from plastics material, which is most commonly transparent, sealed with a covering film, made from plastics or metallic or metalized materials, the product or products being placed in a corresponding cell or cells. Blister packs are also commonly referred to as thermoformed blisters, thermoformed sheets or cellular sheets.

The packaging element may also have at least two sealed and/or bonded sheets, for example, made from aluminum, plastics material and/or paper, arranged in such a way that each product unit is contained in an individual container, for example.

Products that may be stored in a packaging device as described herein may include, for example, any products, particularly chemical products, such as food supplements, cosmetic products, plant protection products, proprietary medicines, vaccines or syringes, or various other products, particular those of small size and/or with a high added value and/or requiring security protection, such as cards for mobile telephones or other electronic equipment, spare parts, jewelry or watches.

In exemplary embodiments in which the product is a proprietary medicine, all pharmaceutical forms may be packaged in the device. For example, doses may take the form of tablets, granules, pills, or gels, typically for oral administration, or suppositories or pessaries for rectal or vaginal administration, respectively, or solutions, powders or creams.

The security elements may form a first-level security system, being detectable by the naked eye by the public without external assistance by any equipment, and may be selected, for example, from among the following: elements using variable and/or diffractive and/or interference optical effects, such as holographic, iridescent or liquid crystal elements; watermarks; impressions with a varnish or a special ink; thermochromic tracers; visible colored fibers and/or planchettes, possibly having different colors, or a mixture of colored fibers and/or planchettes; optical interference filters; Fresnel lens effect elements; lenticular screens; microperforations; metals and/or metallic oxides of different colors; security wires, these wires being metallic, metallized, metallized/demetallized and/or printed, for example, and providing a data element appearing in positive and/or negative form, such as a text, a drawing or a logo; and any combination thereof.

The security elements may also provide a second-level, or possibly a third-level type, detectable with the aid of a suitable detection device that is more or less sophisticated, and selected, for example, from among the following: radio-frequency identification devices (RFID), magnetic or crystalline coatings; bar codes; concealed impressions, such as a digital watermark (a field of concealed encoded points); rare earths; metallic and/or magnetic fibers or particles; tracers detectable by X-ray fluorescence; luminescent (fluorescent or phosphorescent) particles such as fibers, aggregates or microspheres sensitive to infrared radiation or ultraviolet radiation; microspheres; particles visible under UV light; fluorescent nanoparticles, particularly UV quantum dots; elements detectable by microwaves; theft prevention elements; wires with magnetic coding; piezochromic, thermochromic and photochromic tracers; all types of markers, particularly biomarkers, especially DNA-based biomarkers; tracers which change color in contact with one or more predetermined products, and any combination thereof. UV-reacting substances that may be used include pigments re-emitting in the visible spectrum when excited at wavelengths of 365 nm or 254 nm, such as the mineral pigments or organic pigments supplied by the Nemoto and Honeywell companies. It is also possible to use pigments re-emitting in different colors at the two aforementioned wavelengths, such as the CD R/G I pigment supplied by Honeywell.

It is also possible to use what are known as “up-converter” or “anti-Stokes” pigments, which are excited in the infrared range and re-emit in the visible spectrum, such as the Lumilux UC6 pigment supplied by Honeywell. Similarly, it is possible to use pigments that are excited in the ultraviolet range and re-emit in the infrared spectrum, such as the IR CD 139 pigment supplied by Honeywell, which re-emits between 900 and 1000 nm when excited by a wavelength close to 300 nm. It is also possible to use pigments that are excited in the infrared range and re-emit in the infrared range, such as the IR CD 170 pigment supplied by Honeywell, which, when excited at a wavelength of 620 nm, re-emits in the vicinity of 1050 nm.

As regards thermochromic substances, it is possible to use, for example, products of the Matsui company, listed under the name of Chromicolor Aqualite AQ ink. These products are colored at ambient temperature and become colorless at a higher temperature.

Packaging devices comprising combinations of first and second level security elements are also contemplated.

The security elements may be used as authentication means to combat counterfeiting. They may also have a traceability function.

In embodiments comprising a blister pack, the packaging element may include at least one security element on a cover or on an associated sheet, for example, being applied to a surface of the associated sheet or embedded in the plastics material from which the sheet is made. Each packaging element may include a single security element or a plurality of dispersed security elements. The security element or elements may be located, for example, in one or more cells of the blister pack.

In embodiments in which the packaging element includes at least two sealed and/or bonded sheets, the security element or elements may be placed, for example, on one face of at least one of the sheets, or may be located between the sheets, for example, in sealing and/or bonding areas.

At least one security element may remain inside the packaging element, for example, in a compartment containing instructions for use of the product and/or on such instructions themselves.

The packaging element may, for example, include instructions with at least one security element and/or an RFID device in the same compartment as the instructions.

An associated problem in the field of medicine dispensing, where it is desirable to match the number of product units prescribed to the number of product units dispensed, relates to the delivery of instructions for using the products.

For example, if a pharmacist uses the previously described devices according to the aforementioned applications GB 2,223,001 and FR 2,786,158, the pharmacist is obliged to supply the instructions for use of the products separately, requiring additional operations and making it necessary for the pharmacist to file these instructions, such filing being a source of potential errors.

Similar problems may arise in the context of any dispensing of products to be accompanied by the delivery of data, for example, relating to cosmetics, plant protection products or food supplements.

Thus, regardless of whether or not any security elements are present, exemplary embodiments of the packaging device may include a plurality of data media fixed to the packaging elements or belonging to the packaging elements, and arranged in such a way as to enable at least one data medium and at least one packaging element to be detached jointly. The data media may be repeated, for example, between product units on the packaging elements, or may be positioned at least partially beside the product units or may be at least partially superimposed on the product units.

In exemplary embodiments, the packaging device may include a plurality of data media fixed to the packaging elements or belonging to them and arranged in such a way as to enable at least one data medium and at least one packaging element to be detached jointly, the data media not being altered when the product units are taken out of a packaging element during its use.

The data media may form part of the packaging elements or may be applied to the packaging elements.

In exemplary embodiments, the data media may be positioned on the packaging elements between the product units, on the same side as the product units if the product units are positioned on only one side of the packaging elements, or alternatively on the opposite side.

In exemplary embodiments, the data media may be positioned laterally with respect to the packaging elements. The data media may be formed, for example, at least partially by one or more lateral extensions of the packaging elements, or may be applied to the packaging elements, for example, being fixed to marginal areas of the packaging elements, for example, by bonding, welding, stapling or any other appropriate fixing mechanism or arrangement.

A data medium such as instructions may also be contained in a housing of the packaging element. Such an element may, for example, take the form of a blister pack including at least two housings, one receiving the product to be packaged and the other receiving the data medium.

The data media may comprise a material identical to or different from at least one material of the packaging elements.

In exemplary embodiments, the data media may comprise a fibrous material, particularly paper or paperboard, reinforced if necessary with resin such as a synthetic resin if necessary, or with a woven or non-woven fabric.

Alternatively or additionally, the data media may comprise a metal and/or a plastics material, particularly a metallic film or a plastics film.

The data media may include a composite or non-composite structure, for example, comprising at least two layers of different materials.

At least one of the data media may comprise a plurality of sheets, particularly sheets that are bound, for example, by rings, staples, rivets, a weld or an adhesive, this list not being exhaustive.

Two neighboring sheets may be temporarily fixed together, particularly with the aid of an adhesive, such as a pressure-sensitive adhesive.

The data media may be separated from each other by at least one weakening line, for example, positioned in alignment with a weakening line located between two adjacent packaging elements.

In exemplary embodiments, each packaging element may include at least one element capable of interacting with a member for driving the elements, such an element comprising, for example, a perforation positioned to interact with a pin of a drive member.

Preferably, the data media may carry visible data, particularly printed data. The data media may also carry data that may or may not be encrypted.

Data present on the data media may or may not be readily understandable. In cases that the data are not readily understandable, particularly when the data need to be read with the aid of an appropriate reading device, for example, the data being in the form of a bar code or concealed impressions, the data may, for example, be printed in legible form on a separate sheet, either by a pharmacist when the product is a medicine, or by a customer, by a using reading and printing terminal, for example.

The data media may also include one or more security elements as defined above. If the data medium comprises instructions provided at least partially on paper, the instructions may include at least one security element conventionally used in the field of security protection of papers, such as a watermark, a security strip, or the like.

Each data medium may be connected to an associated packaging element in such a way as to make any attempt to separate the two apparent.

At least one of the data media may be folded, particularly with an accordion fold. For example, the data media may contain further data about the product.

In the case of a proprietary medicine, the data media may contain data such as the name of the product, particularly the common name, the pharmaceutical form and the content by weight, by volume or in dose units, the list of excipients, the mode of administration, special warnings, therapeutic indications, the production batch number, the manufacturer's name, the number of the marketing authorization, the expiration date, and all the data and/or instructions concerning the use of the product, particularly its dosage.

Again in the case of a proprietary medicine, each data medium may also include, if required by local regulations, a pharmaceutical label providing various pieces of data about the proprietary medicine concerned. This label may be adhesive and configured to be easily detachable, so that the label may be applied to a treatment record.

Each data medium may include, for example, instructions for use of the product.

Exemplary embodiments of the invention relate to a packaging device comprising: a set of packaging elements, each containing at least one unit of a product, fixed to each other; and a plurality of data media fixed to the packaging elements and belonging to the packaging elements, and positioned so as to enable at least one data medium and at least one packaging element to be detached jointly. The data media may be repeated between the product units or the packaging elements, or may be positioned at least partially to the side of the packaging elements or may be at least partially superimposed on the packaging elements, the data media preferably not being altered at the time of detachment.

Exemplary embodiments of the invention relate to a packaging device comprising: a set of packaging elements, each containing at least one unit of a product, fixed to each other; and a plurality of data media fixed to the packaging elements or belonging to the packaging elements, and positioned in such a way as to enable at least one data medium and at least one packaging element to be detached jointly, the data media not being altered when a product unit is taken out of a packaging element during use.

The expression “not being altered” is to be understood as meaning that the data useful to the user and present on the data medium continues to be readily understood without difficulty. The lack of alteration may, for example, take the form of a lack of tearing or perforation of the data media during use.

The device may comprise a strip formed by a sequence of packaging elements, packaged in a roll or accordion folded, if necessary or desired. The packaging elements may also be assembled by binding.

Exemplary embodiments of the invention relate to a dispenser comprising: a plurality of packaging elements, each comprising at least one unit of a product, fixed to each other or initially contained, particularly in a random arrangement or in a stack, in a single outer container; a plurality of security elements fixed to the packaging elements or belonging to the packaging elements, and positioned so as to allow combined dispensing of at least one packaging element and at least one security element; and a receptacle for at least partially receiving the packaging elements.

Exemplary embodiments of the invention relate to a dispenser comprising: a set of packaging elements, each containing at least one unit of a product, fixed to each other; a plurality of data media fixed to the packaging elements or belonging to the packaging elements, and positioned so as to enable at least one data medium and at least one packaging element to be detached jointly, the data media being repeated between the product units on the packaging elements, or being positioned at least partially to the side of the packaging elements or being at least partially superimposed on the packaging elements; and a receptacle configured to at least partially receiving the packaging elements.

In exemplary embodiments, each of the dispensers described above may include a member for driving or picking out the packaging elements.

The dispensers may be configured to be actuated manually or automatically. Each, if desired, may include at least one member for cutting off the packaging element.

For example, each dispenser may include a reel.

In exemplary embodiments, particularly in which the dispensers are automatically actuated, the dispensers may include a system for selecting a number of product units to be dispensed.

The packaging elements may be stored in the receptacle of the dispenser in the form of a roll, for example, and the driving member of the dispenser may be arranged to cause rotation of such roll.

Each dispenser may include a reading device, particularly one for reading smart cards and/or bar codes.

Thus, a patient having an electronic prescription, stored on a smart card, for example, may cause the number of product units specified on the prescription to be dispensed by using the reading device to read the electronic prescription. The smart card may store data other than that relating to the prescription, and may, for example, contain data relating to the customer's medical records.

Exemplary embodiments of the invention may provide a method for dispensing one or more product units, the product unit or units being carried by a set of packaging elements fixed to each other or being enclosed, particularly in a random arrangement or in stacks, in a single outer container, a plurality of security elements being fixed to the packaging elements or belonging to the packaging elements, and being arranged so as to enable at least one packaging element and at least one security element to be dispensed jointly. The method may comprise jointly dispensing at least one packaging element and at least one associated security element.

At least one security element may be present, for example, on a cover of the packaging element or in a housing of the packaging element, the housing receiving, for example, a data medium such as instructions. The data medium may include at least one security element.

Exemplary embodiments of the invention may provide a method for dispensing one or more product units, the product unit or units being carried by a set of packaging elements fixed to each other, a plurality of data media being fixed to the packaging elements or belonging to the packaging elements, and being arranged so as to enable at least one data medium and at least one packaging element to be dispensed jointly, the data media being repeated between the units on the packaging elements or being positioned at least partially at the side of the packaging elements or being superimposed at least partially on the packaging elements. The method may comprise jointly detaching at least one packaging element and at least one data medium.

Such a method may also include: reading an electronic prescription, particularly one stored on a smart card; and delivering, particularly in an automatic way, the number of packaging elements matching the number of units specified in the electronic prescription.

Exemplary embodiments of the invention may provide a security-protected packaging element to which are fixed at least: a product unit; a security element; and a data medium.

In exemplary embodiments, the security-protected packaging element may include a blister pack with a cell containing a product unit and a cell containing the data medium. The blister pack may advantageously have, by way of a security element, at least one element including a variable optical effect, particularly an interference effect, preferably on a cover thereof, such as a strip that changes color according to an angle of viewing and optionally an RFID device and/or a watermark in the data medium.

### BRIEF DESCRIPTION OF THE DRAWINGS

The invention will be made clearer by the following detailed description of non-restrictive examples of embodiments thereof, and by the attached drawings, in which:

FIG. 1 is a schematic and partial perspective view of an exemplary packaging device;

FIG. 2 is a partial and schematic cross sectional view through an exemplary packaging element;

FIG. 3 shows detail III of FIG. 2;

FIGS. 4 and 5 are views, similar to that of FIG. 3, of other exemplary packaging elements;

FIGS. 6 and 7 are partial and schematic cross sectional views through other exemplary packaging elements;

FIG. 8 shows detail VIII of FIG. 7;

FIG. 9 is a view, similar to that of FIG. 6, of another exemplary packaging element;

FIG. 10 is a schematic and partial perspective view of another exemplary packaging device;

FIG. 11 is a schematic and partial perspective view of another exemplary packaging device;

FIGS. 11 and 12 are schematic and partial perspective views of other exemplary packaging devices;

FIGS. 12 to 20 show, schematically and partially, different exemplary arrangements of a data medium on a packaging element,

FIGS. 21 and 22 are schematic and partial perspective views of other exemplary packaging devices;

FIGS. 23 and 24 show, schematically and partially, exemplary dispensers; and

FIGS. 25 to 27 show schematically, in a view from above, in a cross sectional view and in a view from below, respectively, another exemplary packaging element.

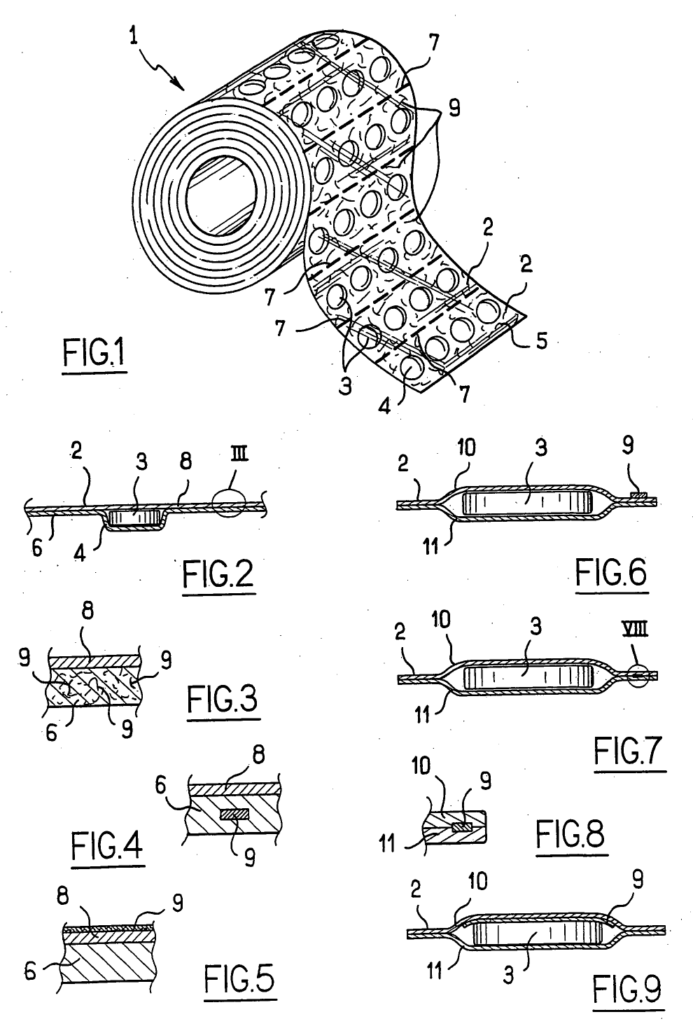

For the sake of clarity, the relative dimensions are not maintained in all cases in the drawings.

### DETAILED DESCRIPTION OF EMBODIMENTS

FIG. 1 shows a packaging device 1 including a plurality of packaging elements 2 for a plurality of product units 3.

In the illustrated example, the packaging elements 2 comprise blister packs 6, each comprising a sheet with cells 4, each containing a product unit 3. The cells 4 of each sheet are closed by a cover 8.

The packaging elements 2 may form a strip 5 packaged in a roll, each packaging element 2 including a line of cells 4, for example.

The strip 5 may include weakening lines 7, each separating two adjacent packaging elements 2. The weakening lines 7 may comprise a series of holes or removals of material, a pre-cut or a weakening related to heat treatment, for example, by a laser.

In the illustrated example, each packaging element 2 has a substantially rectangular shape, a longer side extending perpendicularly to a longitudinal direction of the strip 5.

In this example, the packaging device 1 includes security elements 9 that may be security elements at the first and/or second level(s) described above.

Exemplary first-level security elements which may be mentioned are: elements using variable and/or diffractive and/or interference optical effects, such as holographic, iridescent or liquid crystal elements; watermarks; impressions with a varnish or a special ink; thermochromic tracers; visible colored fibers and/or planchettes, possibly having different colors, or a mixture of colored fibers and/or planchettes; optical interference filters; Fresnel lens effect elements; lenticular screens; microperforations; metals and/or metallic oxides of different colors; security wires, these wires being metallic, metallized, metallized/demetallized and/or printed, for example, and providing a data element appearing in positive and/or negative form, such as a text, a drawing or a logo, and any combination of such security elements.

Exemplary security elements at the second level or above may be selected from: radio-frequency devices (RFID); magnetic or crystalline coatings; bar codes; concealed impressions, such as a digital watermark (a field of concealed encoded points); rare earths; metallic and/or magnetic fibers or particles; tracers detectable by X-ray fluorescence; luminescent particles, particularly fluorescent or phosphorescent ones, such as fibers, aggregates or microspheres sensitive to infrared radiation or ultraviolet radiation; microspheres; particles visible under UV light; fluorescent nanoparticles, particularly UV quantum dots; elements detectable by microwaves; theft prevention elements; wires with magnetic coding; piezochromic, thermochromic and photochromic tracers; all types of markers, particularly biomarkers, especially DNA-based biomarkers; tracers which change color in contact with one or more predetermined products, and any combination of these security elements.

The security elements 9 may or may not be dispersed within each packaging element 2.

In the example shown in FIG. 1, the security elements 9 are produced in the form of fibers, but the security elements 9 may be produced in non-fiber form, for example, in the form of particles.

The security elements 9 may be introduced in bulk into the plastics material or may be present on a surface of such material or on the cover 8.

In embodiments in which the security elements 9 are fibers, the security elements 9 may, for example, be visible and have different colors, so as to provide a first-level security system. The security elements 9 may also be metallic or magnetic, for example, to create a second-level security system.

It is also possible for the security elements 9 not to be dispersed within a packaging element 2, and for each packaging element to include, for example, a single security element, as shown in FIG. 4. The security element 9 may be, for example, a radio-frequency device (RFID) or any other security element selected, for example, from the lists of security elements given above, at the first level, at the second level, or above.

The security element 9 may be, for example, at least partially embedded in the plastics material of the sheet of the blister pack, at the position of a cell or elsewhere.

Each packaging element 2 may also include at least one security element 9 carried by the cover 8.

The cover 8 may be, for example, covered externally by a security element 9, as shown in FIG. 5. The security element 9 may be, for example, a label bonded or welded onto the cover 8 or any surface coating such as, for example, impressions with an ink, for example, a magnetic ink and/or an ink having iridescent pigments.

In another exemplary embodiment, the cover 8 may include optically variable properties, for example, produced by a surface treatment. For example, the cover 8 may be embossed so as to form a hologram.

It is possible for the packaging elements 2 not to comprise blister packs, and the units 3 may, for example, be contained between two sheets 10 and 11, as shown in FIG. 6. Such sheets may be fixed to each other so as to form a sachet or pouch containing the product unit 3.

The sheets 10 and 11 may be, for example, bonded or heat-welded, and may include a composite structure, for example, including a layer of metal, particularly aluminum, laminated with a layer of a thermoplastic material and/or adhesive.

In the case of sachets or pouches, the packaging element 2 may include, for example, a security element 9 carried by one of the sheets 10 and 11, on an exterior of the sheets, for example, in the form of a security strip.

The security element 9 may also be present at the interface between the sheets 10 and 11, as shown in FIG. 8, for example, in the area of the joint between the sheets.

The security element 9 may also be present within the compartment containing the product unit or units 3, for example, being fixed or deposited on an inner surface of one of the sheets.

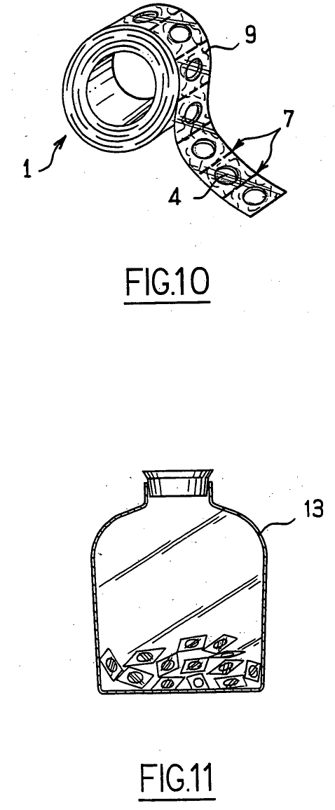

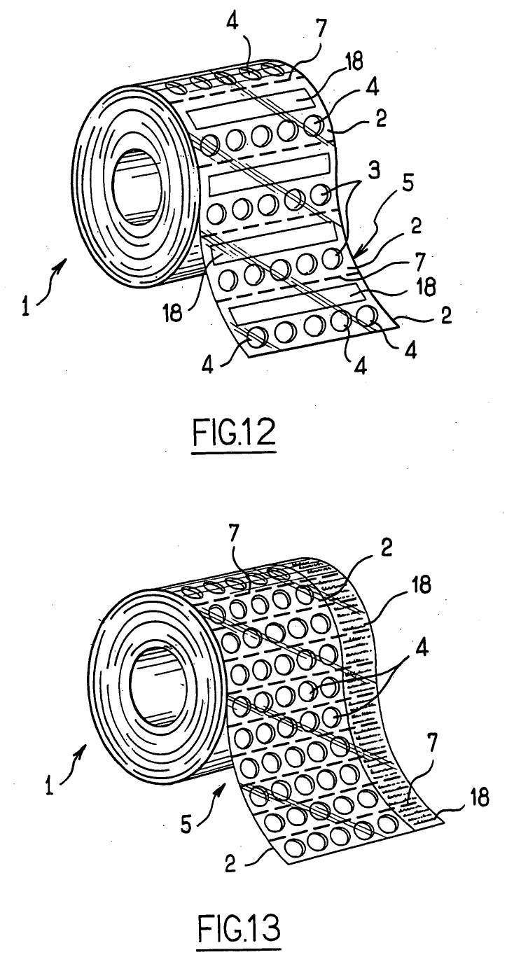

FIG. 10 shows an embodiment in which each packaging element 2 comprises only one product unit 3, enabling a ribbon to be formed.

FIG. 11 shows another exemplary embodiment in which the packaging element 2 contains only one product unit 3 and in which the unit is arranged at random in an outer container 13, which may be a simple jar, for example.

A packaging element 1 may be used, for example, in the following way.

According to a desired number of product units, a user may detach one or more packaging elements 2 from a remainder of the strip 5 along a weakening line 7.

As illustrated, detachment of a packaging element 2 enables at least one security element 9 to be kept fixed thereto, so as to permit authentication and/or traceability analysis regardless of the number of product units detached.

Regardless of whether or not security elements are present within each packaging element 2, the packaging device 1 may include data media 18, as shown in FIG. 12.

In the example of FIG. 12, the packaging device 1 includes, between each pair of lines of cells 4, a data medium 18 including data about conditions of use of the product, for example.

In embodiments in which the product is a proprietary medicine, the data may relate to therapeutic indications and/or dosage, for example.

The data media 18 may include impressions in ink on the packaging elements 2.

Alternatively or additionally, the data media 18 may be applied to the packaging elements 2, by welding or bonding thereto, for example.

Each data medium 18 may include visible wording, such as a text.

Each data medium 18 may include a bar code or concealed and encoded impressions, which may be read to access, particularly via a data or telephone network, for example, the Internet, all or part of instructions on a screen of a computer or of a mobile telephone or any other device, and/or to print such instructions.

In the case of blister packs, the data media 18 may be positioned on faces of the packaging elements 2 on which the cells 4 project, as shown in FIG. 15.

Alternatively or additionally, as shown in FIG. 14, the data media 18 may be positioned on the faces of the packaging elements 2 opposite the cells 4.

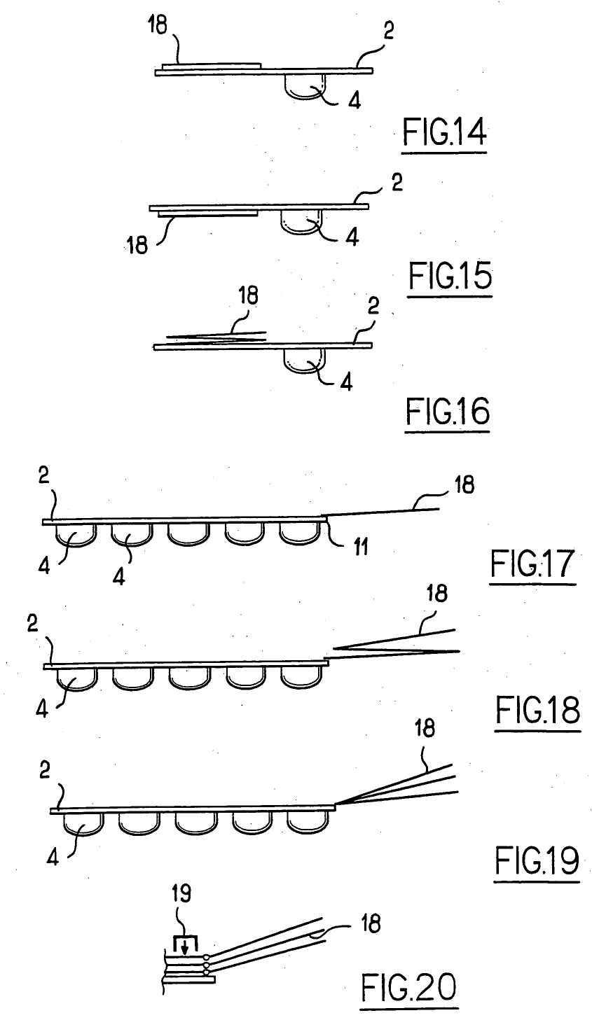

The data media 18 may also comprise an accordion-folded sheet, as shown in FIG. 16, thus increasing the area available for displaying the data.

In the example of FIG. 12, each of the data media 18 is positioned between two lines of cells 4.

Alternatively or additionally, as shown in FIG. 13, the packaging device 1 may include data media 18 positioned along a longitudinal edge of the strip 5. The data media 18 may form lateral extensions of the strip 5.

The data media 18 may be bonded or welded onto a marginal area 11 of the packaging elements 2, as shown in FIG. 17.

To enable a packaging element 2 and a data medium 18 to be detached jointly, the strip 5 may advantageously include a weakening line 7 extending onto the data media 18, as shown in FIG. 13.

Each data medium 18 may comprise an unfolded sheet or, alternatively, an accordion-folded sheet, as shown in FIG. 18.

In another exemplary embodiment, as shown in FIG. 19, each data medium may comprise a plurality of sheets linked along a common border. The sheets may be joined, for example, by staples 19, as shown in FIG. 20. Alternatively or additionally, the sheets may be joined by rivets, bonding or welding, this list not being exhaustive.

In particular, reference may be made to U.S. Pat. No. 6,669,236, which discloses examples of means of assembling data media onto a packaging element.

In some embodiments, the data media 18 may be made from fibrous material, particularly from cellulose and/or synthetic fibers, or in the form of plastics filaments or sheets, particularly those based on polyolefins, particularly those such as the Polyart® synthetic paper made by Arjobex Limited, or may be made from composites, for example, a paper/plastics film composite. The data media 18 may be made, for example, from paper.

If desired to increase the security of the packaging device and/or to ensure its traceability, it is possible to incorporate security elements such as those mentioned above into the data media 18 and/or the packaging elements 2.

For example, it is possible to form an impression on each data media 18 with a security ink, including, for example, magnetic pigments and/or optically variable pigments. It is also possible to incorporate magnetic or other markers or fibers in the fibers of each data medium 18, when the data medium 18 is made from paper, for example.

It is also possible, particularly in the case of the example of FIG. 13, to include a security strip extending along the edge of the strip on the successive data media 18.

The packaging device 1, when provided with data media 18, may be used, for example, in the following way.

According to the desired number of product units, the user may detach one or more packaging elements 2 from a remainder of the strip 5 along a weakening line 7.

It is possible for the detachment of a packaging element 2 not to affect the associated data medium 18.

The data media 18 may remain fixed to the packaging elements 2 after the detachment of the packaging elements 2.

Furthermore, when a product unit 3 is taken out of its cell 4, the data medium 8 may remain intact.

In the examples of FIGS. 12 and 13, for example, the packaging elements 2 may form a strip packaged in the form of a roll.

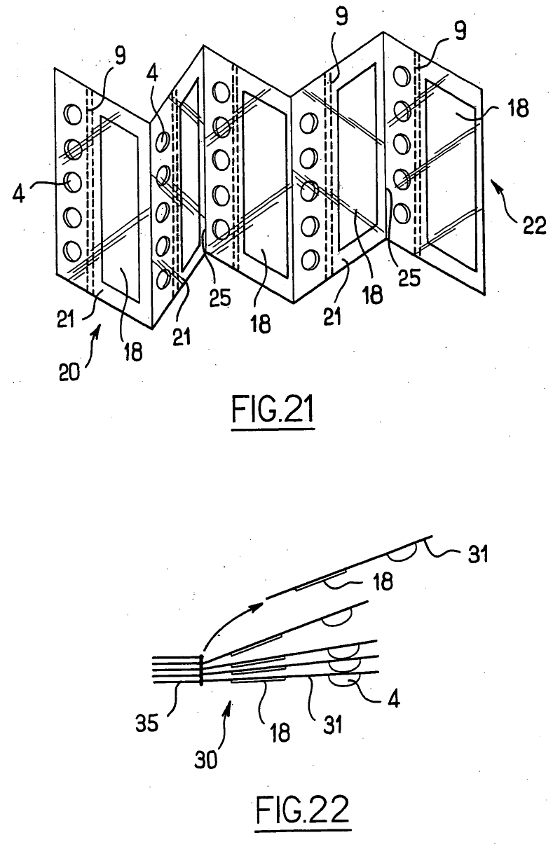

FIG. 21 shows an exemplary packaging device 20 including a plurality of packaging elements 21, each of which, like the previously described packaging elements 2, includes a line of cells 4 and a data medium 18.

The packaging elements 21 may form an accordion-folded strip 22.

In this example, the folding lines 25 correspond to the weakening lines used to detach the packaging elements 21.

Each packaging element 21 may include a security strip 9 embedded in a layer of the packaging element 21. The security strip 9 may be, for example, a metallized strip with inscriptions that are transparently visible in transmitted light.

FIG. 22 shows another exemplary packaging device 30 including a plurality of packaging elements 31.

The packaging elements 31 may be assembled by a binding 35 arranged to enable the packaging elements 31 to be detached as desired or required.

The packaging elements 31 may be joined, for example, by bonding or welding, when the material of the packaging elements 31 permits such joining.

Alternatively, the packaging elements 31 may be joined by spirals or any other appropriate mechanism or assembly arrangement.

FIG. 22 shows an exemplary dispenser 40 including a receptacle 41, particularly a box, made of paperboard, for example, configured to receive a packaging device 1 in roll form.

The receptacle 41 may include an opening 42 through which one end of the strip 5 extends.

To use the dispenser 40, the user may pull the strip 5 to take out a desired number of packaging elements 2.

The user then may detach the packaging element or elements 2 corresponding to the desired quantity from a remainder of the strip 5.

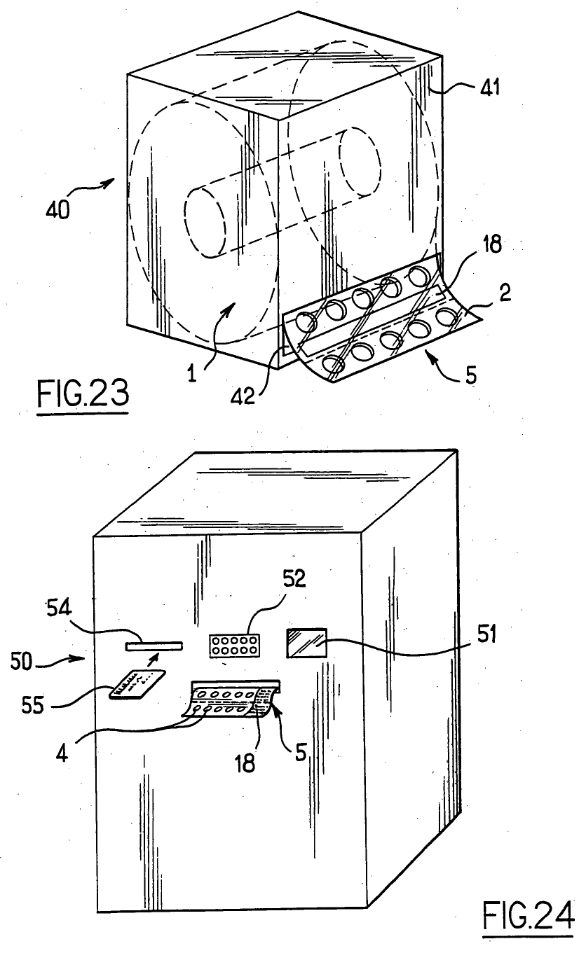

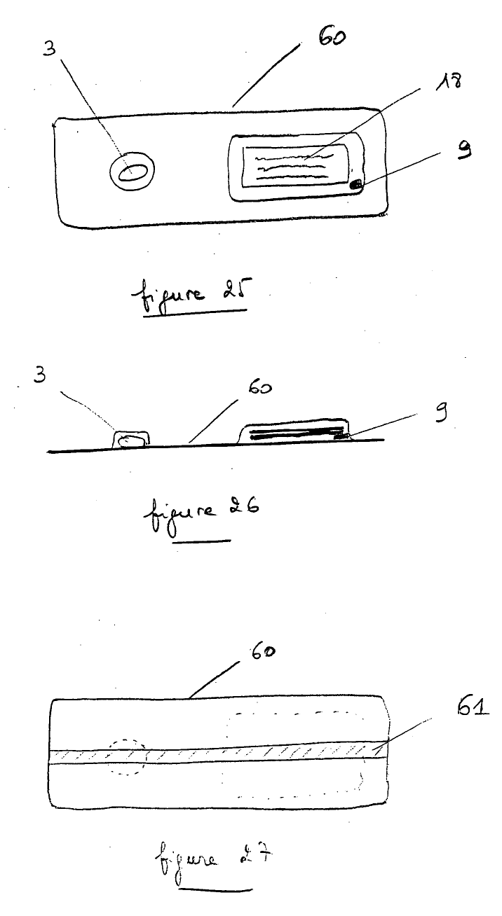

FIG. 23 shows an exemplary dispenser 50 configured to automatically dispense product units packaged in the packaging device 1.

This dispenser 50 may include a cut-off member for detaching one or more packaging elements 2 from a remainder of the strip 5, a payment device 51 enabling a user to adjust the amount corresponding to the delivered products, and, if necessary or desired, a selection system 52 enabling the desired number of product units to be selected.

The dispenser 50 may also have a smart card reader 54. Thus, a user provided with an electronic prescription stored on a smart card 55 may have the doses specified in the prescription dispensed by inserting his card 55 into the reading device 54.

FIGS. 25 to 27 show another exemplary packaging element that may be packaged in batches in a single outer container, such as a jar or a box, or in an elevator device.

The packaging element 60 shown in FIGS. 25 to 27 comprises a blister pack having two thermoformed cells, one containing a product unit 3 and the other containing a data medium, comprising instructions for use 18 in this case.

The blister pack has a metallized cover to which is applied a security element, such as a variable optical effect strip 61. In this example, the strip 61 has a goniochromatic effect and changes, for example, from blue to green according to the viewing angle.

The instructions 18 may also contain a security element, such as a watermark.

Another security element 9, such as an RFID device, may, if necessary or desired, be contained in the same cell as the instructions 18.

The expressions “having a”, “comprising” or “including” are to be understood as being synonymous with “having at least one”, “comprising at least one” and “including at least one” unless specified otherwise.

All the characteristics of the different exemplary embodiments may or may not be combined with each other to form additional embodiments, which are not shown.

Although the present invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention.

What is claimed is:

1. A packaging device, comprising:
a plurality of packaging elements, each comprising at least one unit of a product, the plurality of packaging elements being at least one of fixed to each other and contained in a single outer container; and
a plurality of safety elements at least one of belonging to the packaging elements and fixed to the packaging elements, and positioned so as to allow a combined dispensing of at least one packaging element and at least one security element.

2. The packaging device according to claim 1, further comprising a strip formed by a succession of packaging elements.

3. The device according to claim 1, wherein two adjacent packaging elements are separated by at least one weakening line that enables the two adjacent packaging elements to be separated.

4. The device according to claim 3, wherein the at least one weakening line comprises at least one of a series of holes, a series of removals of material, a pre-cut and a weakening.

5. The device according to claim 4, wherein the at least one weakening line is generated by heat treatment.

6. The device according to claim 5, wherein the at least one weakening line is generated with by a laser.

7. The device according to claim 2, wherein the strip is packaged in roll form.

8. The device according to claim 2, wherein the strip is packaged in a folded form.

9. The device according to claim 8, wherein the strip is packaged in an accordion folded form.

10. The device according to claim 1, wherein the packaging elements are assembled by a binding.

11. The device according to claim 1, wherein the packaging elements are enclosed in a single outer container and each packaging element includes a security element.

12. The device according to claim 11, wherein the packaging elements are enclosed in a random arrangement in the outer container.

13. The device according to claim 1, wherein each packaging element comprises a plurality of product units arranged in at least one line.

14. The device according to claim 1, wherein a number of product units per packaging element is in a range from 1 to 10.

15. The device according to claim 1, wherein each packaging element comprises a blister pack.

16. The device according to claim 1, wherein each packaging element comprises at least one of a pouch and a sachet.

17. The device according to claim 1, wherein each of the security elements comprises at least one element selected from: an element using at least one of a variable, a diffractive, and an interference optical effect; a holographic element; an iridescent element; a liquid crystal element; a watermark; an impression using a varnish; an impression using a special ink; a thermochromic tracer; a visible colored fiber; a visible colored planchette; a mixture of colored fibers; a mixture of colored planchettes; an optical interference filter; a Fresnel lens effect element; a lenticular screen; a microperforation; a metal; a metallic oxide; metals of different colors; metallic oxides of different colors; a security strip; a metallic security strip; a metallized security strip; a metallized/demetallized security strip; a printed security strip; a security strip including a data element appearing in positive form; a security strip including a data element appearing in negative form; a security strip including a data element appearing in a text; a security strip including a data element appearing in a drawing; a security strip including a data element appearing in a logo; a magnetic coating; a crystalline coating; a radio-frequency identification (RFID) device; a bar code; a concealed impression; a concealed impression comprising a digital watermark; a rare earth element; a metallic fiber; a metallic particle; a magnetic fiber; a magnetic particle; a tracer detectable by X-ray fluorescence; a luminescent particle; a fluorescent particle; a phosphorescent particle; a particle sensitive to infrared radiation; a particle sensitive to ultraviolet radiation; a fiber sensitive to infrared radiation; a fiber sensitive to ultraviolet radiation; an aggregate sensitive to infrared radiation; an aggregate sensitive to ultraviolet radiation; a microsphere sensitive to infrared radiation; a microsphere sensitive to ultraviolet radiation; a particle visible under UV light; a fluorescent nanoparticle; a UV quantum dot; an element detectable by microwaves; a theft prevention element; a wire with magnetic coding; a piezochromic tracer; a photochromic tracer; a marker; a biomarker; a DNA-based biomarker; a tracer that changes color in contact with at least one predetermined product; and any combination thereof.

18. The device according to claim 1, further comprising a plurality of data media, the plurality of data media at least one of belonging to the packaging elements and fixed to the packaging elements, and positioned so as to enable at least one data medium and at least one packaging element to be detached jointly.

19. The device according to claim 18, wherein the data media are repeated between units of the product on the packaging elements.

20. The device according to claim 18, wherein the data media are positioned at least partially to a side of the packaging elements.

21. The device according to claim 18, wherein the data media are at least partially superimposed on the packaging elements.

22. The device according to claim 1, further comprising a plurality of data media, the plurality of data media at least one of belonging to the packaging elements and fixed to the packaging elements, and positioned in such a way as to enable at least one data medium and at least one packaging element to be detached jointly, the data media not being altered when the at least one unit of the product is taken out of one of the packaging elements for use.

23. The device according to claim 18, wherein the data media form part of the packaging elements.

24. The device according to claim 18, wherein the data media are applied to the packaging elements.

25. The device according to claim 18, wherein the data media are positioned on the packaging elements, between units of the product.

26. The device according to claim 18, wherein the data media are positioned laterally with respect to the packaging elements.

27. The device according to claim 26, wherein the data media are formed at least partially by at least one lateral extension of the packaging elements.

28. The device according to claim 18, wherein at least one of the data media comprises a plurality of sheets joined together.

29. The device according to claim 18, wherein the data media are separated by at least one weakening line.

30. A device according to claim 29, wherein the data media are positioned in alignment with a weakening line between two adjacent packaging elements.

31. The device according to claim 18, wherein at least one data medium comprises at least one of a bar code, a concealed impression and an encoded impression, reading of which accesses at least part of instructions for the product.

32. A packaging device comprising:
a set of packaging elements, each packaging element containing at least one unit of a product, the packaging elements being fixed to each other; and
a plurality of data media at least one of fixed to the packaging elements and belonging to the packaging elements, and positioned so as to enable at least one data medium and at least one packaging element to be detached jointly, the data media at least one of being repeated between units of the product on the packaging elements, being positioned at least partially to a side of the packaging elements, and being at least partially superimposed on the packaging elements.

33. A packaging device comprising:
a set of packaging elements, each packaging element containing at least one unit of a product, the packaging elements being fixed to each other; and
a plurality of data media at least one of fixed to the packaging elements and belonging to the packaging elements and positioned in such a way as to enable at least one data medium and at least one packaging element to be detached jointly, the data media not being altered when the at least one unit of product is taken out of one of the packaging elements during use.

34. The device according to claim 1, wherein the product comprises at least one product selected from: a proprietary medicine; a proprietary medical product; a vaccine; a syringe; a telephone card; electronic equipment; a spare part; a piece of jewelry; and a watch.

35. A dispenser comprising:
a plurality of packaging elements, each comprising at least one unit of a product, the packaging elements being at least one of fixed to each other and contained in a single outer container;
a plurality of security elements at least one of fixed to the packaging elements and belonging to the packaging elements, and positioned so as to enable at least one packaging element and at least one security element to be dispensed jointly; and
a receptacle for at least partially receiving the packaging elements.

36. A dispenser comprising:
a set of packaging elements, each containing at least one unit of a product, fixed to each other,
a plurality of data media at least one of fixed to the packaging elements and belonging to the packaging elements, and positioned so as to enable at least one data medium and at least one packaging element to be detached jointly, the data media being at least one of repeated between units of the product on the packaging elements, positioned at least partially to a side of the packaging elements, and at least partially superimposed on the packaging elements; and
a receptacle configured to at least partially receive the packaging elements.

37. A method for dispensing at least one product unit, the at least one product unit being carried by a set of packaging elements at least one of fixed to each other and enclosed in a single outer container, a plurality of security elements at least one of being fixed to the packaging elements and belonging to the packaging elements, and being arranged so as to enable at least one packaging element and at least one security element to be dispensed jointly, the method comprising:
jointly dispensing at least one packaging element and at least one security element.

38. A method for dispensing at least one product unit, the at least one product unit being carried by a set of packaging elements fixed to each other, a plurality of data media being at least one of fixed to the packaging elements and belonging to the packaging elements, and being arranged so as to enable at least one data medium and at least one packaging element to be dispensed jointly, the data media being at least one of repeated between units of the product on the packaging elements, positioned at least partially at a side of the packaging elements, and superimposed at least partially on the packaging elements, the method comprising:
jointly detaching at least one packaging element and at least one data medium.

39. The method according to claim 35, further comprising:
reading an electronic prescription; and
delivering a number of packaging elements matching a number of product units specified in the electronic prescription.

40. A security-protected packaging element, comprising at least the following fixed thereto:
a product unit;
a security element; and
a data medium.

41. The packaging element according to claim 40, further comprising a blister pack including a cell containing the product unit and another cell containing the data medium.

42. The packaging element according to claim 40, further comprising at least one security element with a variable optical effect on a cover.

43. The packaging element according to claim 42, further comprising at least one of an RFID tag and a watermark in the data medium.

44. The packaging element according to claim 42, wherein the data medium comprises instructions on paper and the instructions include at least one security element.
